(19) United States
(12) Patent Application Publication
(10) Pub. No.: US 2017/0075519 A1
(43) Pub. Date: Mar. 16, 2017

(54) Data Butler

(71) Applicant: REHABILITATION INSTITUTE OF CHICAGO, Chicago, IL (US)

(72) Inventors: Konrad Kording, Chicago, IL (US); Daniel Acuna, Chicago, IL (US); Titipat Achakulvisut, Chicago, IL (US)

(21) Appl. No.: 15/266,695

(22) Filed: Sep. 15, 2016

Related U.S. Application Data
(60) Provisional application No. 62/218,998, filed on Sep. 15, 2015.

(51) Int. Cl. G06F 3/0482; G06F 17/30; G06F 17/27

(52) U.S. Cl. CPC G06F 3/0482; G06F 17/2785; G06F 17/3053

(57) ABSTRACT

In an embodiment, a computer-implemented method of displaying information within a window displayed on a graphical user interface is disclosed. The method may comprise displaying in the window a plurality of document summaries; displaying in the window, for each document summary in the list, a relevance input object; receiving a relevance value from the relevance input object; and updating the window display with a revised plurality of document summaries, wherein the revised plurality of document summaries are ordered by a relevance determined at least in part by the relevance value. The relevance of the revised plurality of document summaries may be determined at least in part using latent semantic analysis.

### FIELD

The invention relates to determining, from a set of information, which of it is more or less relevant to one or more users.

### BACKGROUND

Conferences can bring people from all over the world to share their new ideas with one another. For example, the Society for Neuroscience has an annual meeting for neuroscientists to present emerging science, learn from experts, and collaborate with their peers, and explore new tools and technologies. Tens of thousands of individuals from most countries attend this conference over a multi-day period. Similarly sized conferences are held regularly throughout the world.

It is not possible for one person to learn all the information presented at a large conference, and so attendees must try to identify the presentations that are most relevant to their field of interest. Systems and methods are needed to improve the ability of an attendee to identify the most relevant information presented during a conference.

The problem of finding relevance in a large quantity of data is not unique to attendees at conferences. Anyone who has used the internet knows that vast amounts of data are available for people to review. Businesses in a variety of industries have developed “big data” and now struggle with determining its relevance. A key challenge in all of these areas is determining which information may be relevant to a particular user.

The word “butler” comes from Anglo-Norman word buteler, corresponding to the Old French term botellier meaning “the officer in charge of the king's wine bottles” and derived from the French boteille, for “bottle.” Wikipedia gives this description of today's popular image of a butler: “the real-life modern butler attempts to be discreet and unobtrusive, friendly but not familiar, keenly anticipative of the needs of his or her employer, and graceful and precise in execution of duty.” A data butler is needed to help users determine which information is or is not relevant to them, across a wide variety of information fields.

### DESCRIPTION OF THE FIGURES

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the inventions.

FIG. 1 depicts an embodiment of a window displayed on a graphical interface.

FIG. 2 depicts an embodiment of a window displayed on a graphical interface, displaying embodiments of document summaries.

FIG. 3 depicts an embodiment of a document summary.

FIG. 4 depicts an embodiment of a window displayed on a graphical interface, displaying embodiments of document summaries that may be more relevant to the user.

FIG. 5 depicts an embodiment of an updated window.

FIG. 6 depicts a flow chart of exemplary initial steps in preparing documents for a relevance determination.

FIG. 7 depicts a simplified example of a weighted token matrix.

FIG. 8 depicts an embodiment of a flowchart setting out steps to determine which documents may be relevant to a user in response to a relevance value.

FIG. 9 depicts a plot of points of vectors, where each vector represents a sample document.

FIG. 10 depicts an exemplary computer architecture used in connection with the determination and/or display of relevant documents.

### DETAILED DESCRIPTION

In the following description, for purposes of explanation and not limitation, specific details are set forth such as particular structures, architectures, interfaces, techniques, etc. in order to provide a thorough understanding of the various aspects of a data butler to help a user identify relevant information from a large set of data. However, it will be apparent to those skilled in the art having the benefit of the present disclosure that the various aspects of the invention may be practiced in other examples that depart from these specific details. In certain instances, descriptions of well-known devices, circuits, and methods are omitted so as not to obscure the description of the present invention with unnecessary detail.

In an embodiment, a matching system, also known as a data butler, is provided that produces an automated schedule for visitors of a conference, such as a scientific conference or a trade show. The matching system may provide for large-scale matching capabilities. The matching system may produce an automated schedule for individual visitors of the conference. The matching system may match visitors to information of interest, such as a poster. In an embodiment, the system assigns no more than 50 visitors per poster and schedules about 20 posters per day per visitor. In an embodiment, the matching algorithm does not match a visitor to his or her own poster, or a poster of his or her own lab or organization. In an embodiment, the system uses only the abstracts of the posters being presented to produce the automated schedule. In an embodiment, the data butler reduces the amount of human intervention required to produce the automated schedule.

The description below sets out in greater detail the use of the systems and methods described in the context of an academic conference. As discussed in further detail, it can be used by a conference participant to select posters or presentations that are related specifically to his or her field. However, it should be understood that the systems and methods described are useful in a wide variety of fields and situations where it is useful for a user to receive a display of an ordered listing of documents, where the listing of the documents is ordered by a relevance determined at least in part by a relevance value provided by the user.

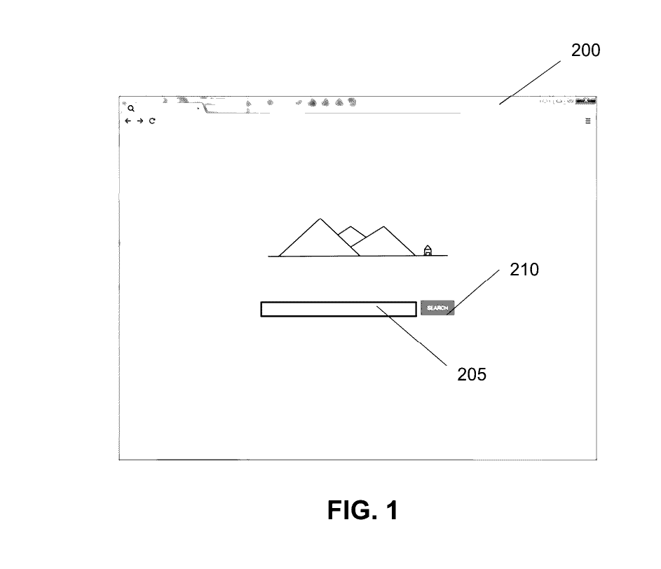

FIG. 1 depicts a window 200 displayed on a graphical user interface. An input box 205 and a search button 210 are displayed in the window 200. The window 200 may be displayed on a display 305 of a computer 300 (described further below). A user may enter text in the input box 205 and activate the search button 210, such as by pressing the search button 210 (if the display 305 is responsive to human touch), clicking the search button 210 (if the display 305 is coupled to an input mechanism such as a mouse), or otherwise activating the search button 210. Activating the search button 210 causes the documents 100 to be searched with the text entered by the user. For instance, the documents 100 may be searched for the word “computation.” In an embodiment, only the titles of the documents are searched. In another embodiment, the titles and the abstracts of the documents are searched. Other combinations are also possible.

The documents may be stored in a storage 350. For example, the storage 350 may contain documents 100 that comprise the text of conference papers to be presented at a conference. As another example, the storage 350 may contain documents 100 that comprise the abstract of conference papers to be presented at a conference.

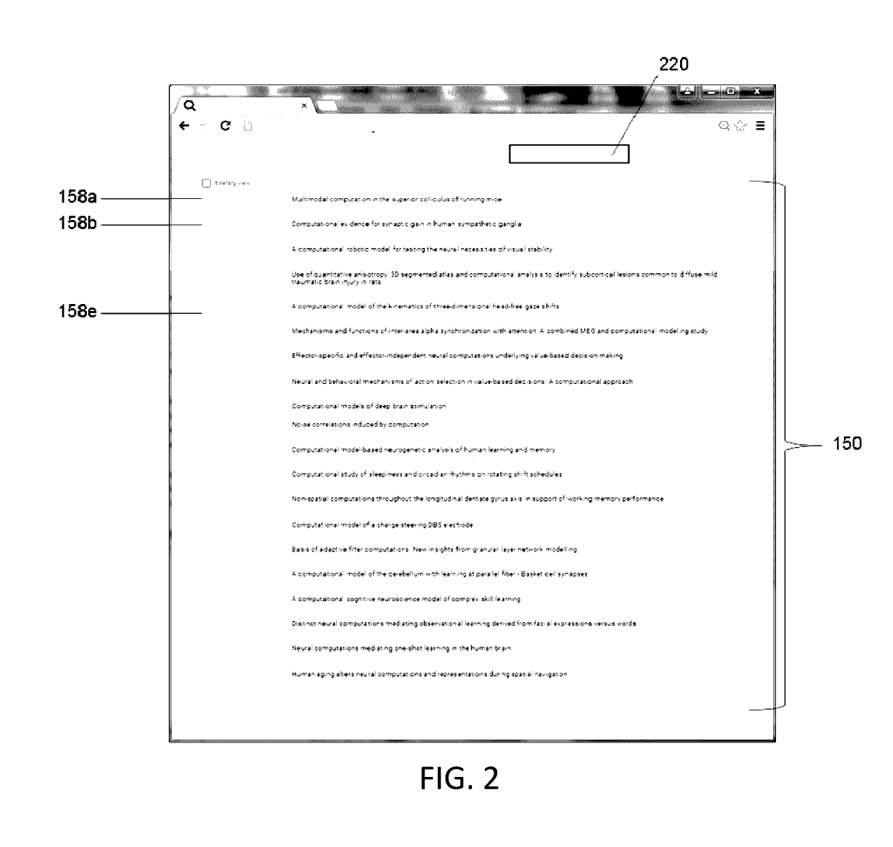

As shown in FIG. 2, window 200 may be updated with document summaries 150 that match the search text entered by the user. In the embodiment depicted in FIG. 2, twenty document summaries 150 are displayed in response to the user's search. In an embodiment, each document summary 150d comprises the title of the document 100d and the author or authors of the document 100d. In an embodiment, the search results are ordered by the day and time the paper will be presented at the conference. In another embodiment, the search results are ordered by an initial relevance determination, based on known methods in the field. One of skill in the art will recognize there are also other ways to order the initial search results.

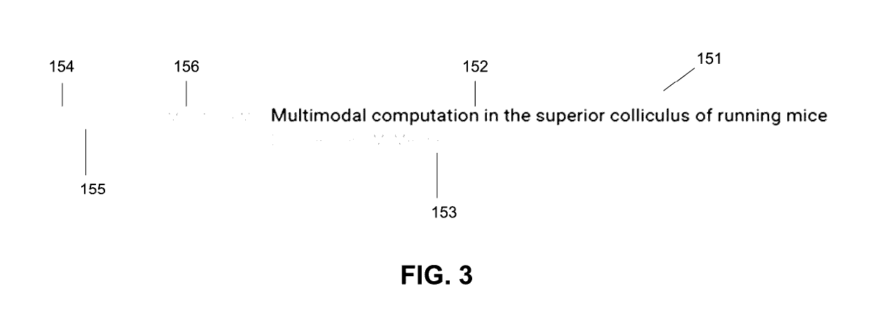

The window 200 may display at least one relevance input object associated with each document summary. FIG. 3 depicts a display of a single document summary 151 on the window 200. As shown in FIG. 3, the document summary 151 displays the title 152 of the document 100d, the author or authors 153 of the document 100d, a first relevance input object 154 and a second relevance input object 155. If the document has a time relation, the window 200 may also display a time value 156, such as the date and time a conference paper will be presented at a conference. Although relevance input objects 154 and 155 are displayed as a check mark symbol and an X mark symbol in the embodiment depicted in FIG. 3, other symbols could be used, such as hearts, stars, an image of a thumb pointing up, or an image of a thumb pointing down.

Even though the document summaries 150 are returned to the user on the basis of search text provided by the user, the document summaries 150 displayed may be of varying relevance to the user, based on his or her field of study or other interest. Therefore, the user is provided with the opportunity to identify whether a particular document summary shown in the window 200 is relevant or not relevant, using the relevance input objects 154 and 155.

The user of the computer 300 may indicate whether document summary 151 is relevant by activating relevance input object 154, such as by clicking or pressing it. The user of the computer 300 also may indicate whether document summary 151 is not relevant to him or her by activating relevance input object 155. Activating the relevance input object 154 or 155 causes the computer 305 to receive a relevance value 157 for the document summary 151, which may be a “1” or a “0” or another appropriate value. For instance, if the relevance input object is a plurality of stars, the relevance value 157 may reflect the number of stars selected by the user.

In an embodiment, the user may indicate a relevance value 157 for multiple document summaries displayed on the window 200. For example, the user might indicate that document summary 158a is not relevant but document summaries 158b and 158e are relevant. After making the indication, the user may activate the suggestion button 220 for the computer 305 to receive the relevance value 157. Alternately, the computer 305 may receive the relevance value 157 directly after the user activates an input object.

In response to receiving the relevance value 157, a revised plurality of documents 105 may be determined in response to the relevance value 157, as described in further detail below. A revised plurality of document summaries 150 for the documents 105 may then be displayed in the window 200. In an embodiment, the revised plurality of document summaries 150 may be ordered by relevance in response to the relevance value 157. In an embodiment, the revised plurality of document summaries 150 may differ from the document summaries 150 initially presented to the user, because the revised plurality of document summaries 150 are more relevant to the user than those presented in the initial search results.

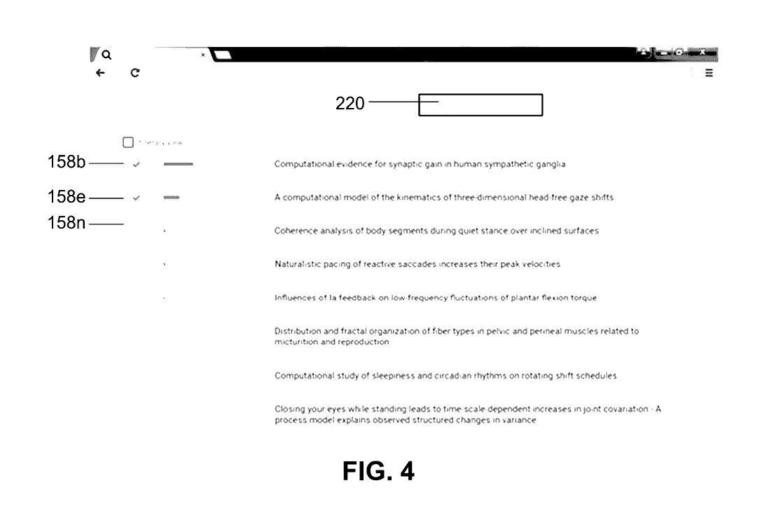

For example, the embodiment shown in FIG. 4 depicts the window 200 displaying document summaries for the revised plurality of documents 105. Document summaries 158b and 158e are now shown at the top of the list in the window 200. Additionally, document 158n, not shown in the original listing depicted in FIG. 2, is now presented as third in the list. This new display reflects the determination that document 158n is related to documents 158b and 158e (using systems and methods described below) and therefore, after documents 158b and 158e, document 158n may be more relevant to the user than the other documents in documents 100. A bar 159 may be displayed to indicate the likelihood of each displayed document summary being relevant to the user, on the basis of the user's prior selections. The user may continue to indicate whether documents shown in the window 200 are relevant or not relevant, and again update the results in the same manner as described above. For instance, as the user continues to active relevance input objects for document summaries, the window 200 continues to update the document summary to display the document summaries that are most likely most relevant to the user, based on prior relevance selections. The document summaries the user has selected as relevant or not relevant may be highlighted in the display. For instance, the relevance input object may be colored based on the relevance to the user. As an example, document summaries the user has marked relevant may have the relevance input object 154 highlighted in green and documents marked irrelevant may have the relevance input object 155 marked in yellow.

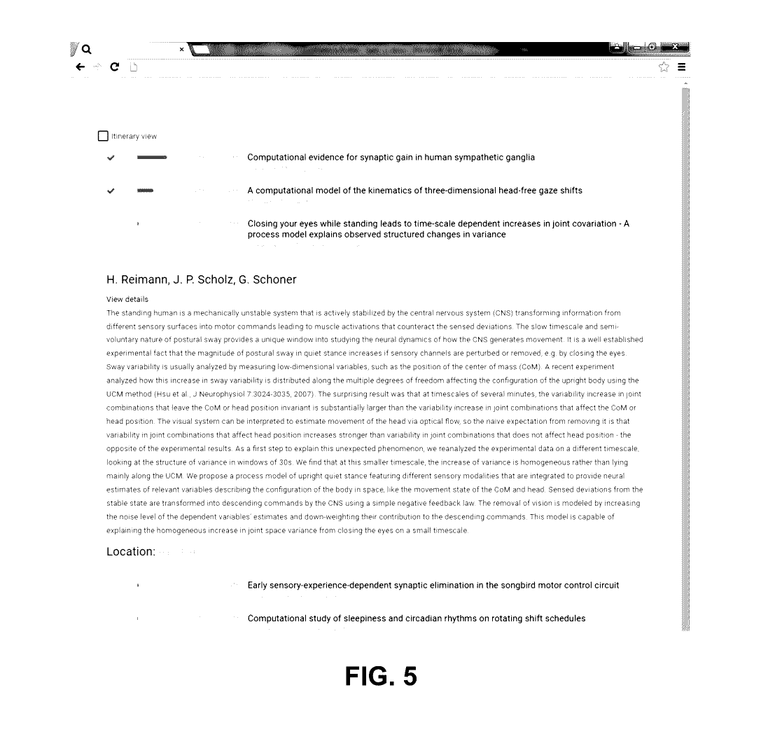

In an embodiment, the window 200 is displayed using existing technologies, such as JAVASCRIPT, that allow only a portion of the window 200 to be updated. This functionality can make results appear more quickly for the user. For instance, each document summary may be stored as a DOM object. When the computer 300 receives the revised plurality of document summaries 150 for the documents 105, the computer 300 may compare the revised list with the prior list and update only the DOM objects that require updating. Similar update technologies may be used to display additional information about a document by clicking on a document summary. For instance, clicking the title of a document summary may cause the display 200 to be updated and show the abstract for that document, as shown in FIG. 5.

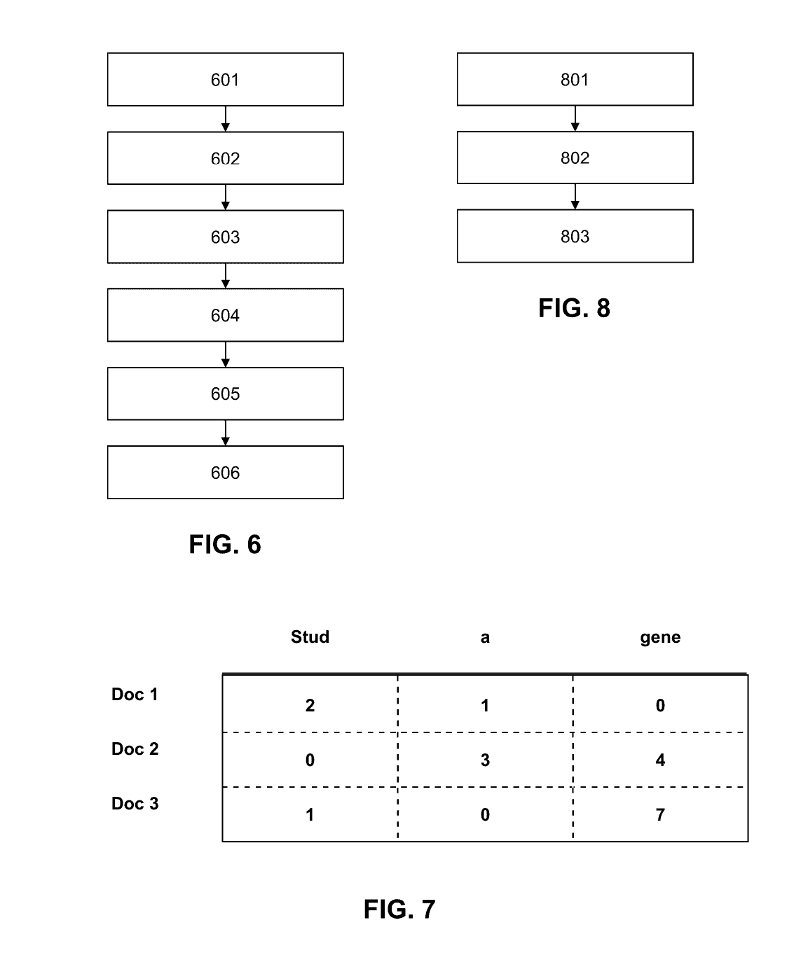

We now turn to describing certain embodiments for and methods of determining which documents may be more relevant to a user in response to a relevance value. In an embodiment, latent semantic analysis may be performed on the documents 100. As an initial matter, certain steps may be performed initially in order to prepare for determining relevance. FIG. 6 displays a flow chart of steps that may be taken initially. In 601, the computer receives a plurality of documents 100. A document of the documents 100 is referred to herein as document 100d. Documents 100 may contain various kinds of information, depending on the nature of the use of the systems and methods described herein. For the use in an academic conference, a document may comprise a text abstract of a poster or paper being presented at the conference. In other embodiments, the document may contain different kinds of information. For example, the document may contain other kinds of text, or may contain information about kinds of multimedia that may be relevant to the user. For example, the systems and methods described herein may be used to match users with music or movies that of relevance to the user. In those uses, a document may contain information about one or more features of the multimedia. For music, for example, the features may include information about the types of instruments used to make the music, the qualities of the vocal aspects of the music, and other such features.

In 602, the documents 100 are cleaned. For example, if a document 100d is a text document, such as a text abstract of a conference poster, the document 100d may be cleaned by removing subwords, such as stopping words (for example, ‘a’ or ‘the’) which appear in most or all documents, and punctuation. The document 100d may also be cleaned by removing other text that is not useful for the particular field of study. For example, in the field of biology, certain organisms or diseases are identified by number, and so numbers are an important kind of information to retain to help identify an ordered list of documents for the user. In the field of computer science, certain numbers more often indicate results, and so are less useful to identify an ordered list of documents for the user. Therefore, if the document relates to a field where numbers in the text are relatively less useful (such as computer science), then in 602 the numbers in the document may be removed.

In 603, the documents 100 may be stemmed. For example, if a document 100d is a text document, then the document 100d may be stemmed by retaining the root of each word in the document but discarding the stems. For instance, the words “studying” and “studies” each become “studi”. The root term is known herein as a “token”. The set of tokens in a document 100d is referred to herein as 100dt and the set of tokens in all documents 100 is referred to herein as 100t.

In 604, a bag of words analysis is performed, wherein each document 100d is reviewed to count the number of times a token appears in the document 100d. For instance, if the token “studi” appears 10 times in a document 100d, then the token count of “studi” for that document 100d is equal to 10.

In 605, the token count is weighted to reflect the importance of a token in the documents 100. Some common words, like “a” or “the”, will likely appear in most text documents, for instance, and so step 605 is taken to reflect the importance of the token in the documents 100. In an embodiment, term frequency inverse document frequency (tf-idf for short) may be used in 605. In the example provided above, a count of the token “studi” may be revised to equal its former value (equal to 10) divided by the number of documents in documents 100 in which the token “stud” appeared. It should be apparent to one skilled in the art that other methods may be employed to weight the value of tokens 100t in order to reflect their importance in the documents 100. Such examples may include a logarithmic transformation to the term frequencies and document frequencies, or a normalization of the term frequency so that values are within pre-specified lower and upper bounds.

In 605, a weighted token matrix 120 may be prepared that includes the value of each token for each document in documents 100. A simplified example of a weighted token matrix is shown in FIG. 7, with documents doc1, doc2, and doc3 and three tokens “stud”, “a”, and “gene”. For example, the token value “stud” is weighted with a value of “2” for document doc1. A token is weighted with a value of “0” if it is not present in the document.

It should be understood that in certain uses, the weighted token matrix 120 will have millions of tokens, or potentially billions of tokens or more for very large datasets of documents. To simplify the final analysis and potentially to produce better results, in 606, a dimensionality reduction may be performed on the weighted token matrix 120. For example, truncated singular valued analysis may be performed on the weighted token matrix 120. It is known by the inventors that certain tokens are used together with an increased frequency. A dimension reduction such as truncated singular value decomposition (or SVD for short) helps to determine which tokens are used together with frequency in the documents 100. Dimensionality reduction algorithms are available in many standard computer software packages, such as Matlab, R, or Python, and so are not described here further. The result of the dimensionality reduction may be a vector 100dv for each document 100d, where the values of the vector describe a fingerprint of the document. In other embodiments, other dimensionality reduction methods may be employed, such as Principal Component Analysis, Non-negative Matrix Factorization, Sparse Matrix Factorization or Isomap. The number of dimensions to return after the dimensionality reduction method may be specified in advance of the reduction or determined during runtime, e.g. through nuclear norm minimization. In an embodiment, the number of dimensions may be chosen to capture a pre-specified level of a certain percentage of the total variance in a selected data set. For example, for a certain data set, 400 dimensions may be selected because they capture a pre-specified level of 95% of the total variance in the data set. The number of dimensions may be optimized for a given objective. For example, the number of dimensions can be optimized for user satisfaction, for statistical reasons (as in non-parametric Bayesian approaches), or for computational reasons.

FIG. 8 depicts a flowchart of steps that may be taken to determine which documents may be relevant to a user in response to a relevance value. In 801, a relevance reference may be created or modified. A relevance reference may be created, for instance, when a user indicates that one document summary 150d from a set of the documents 100 is relevant to that user. FIG. 9 shows a plot of points, providing a visual representation of a simplified set of vectors 100v where each vector has only two dimensions. Each point represents a vector of a document. As shown in FIG. 9, the user has indicated that document d1 is relevant, and so the relevant reference 140 is set equal to d1.

In 802, a set of documents 105 may be identified that are nearest neighbors to the relevant reference 140. The documents 105 may be identified using nearest neighbor methods known in the art, such as Euclidean or Manhattan distance. In an embodiment, an approximate nearest neighbor search strategy may be employed, where the space of documents is recursively separated in a tree-like structure, where each leaf of the tree defines a “ball” that contains many documents. The number of branches and depth of the tree affects the search speed and the accuracy of the search. Other methods for finding nearest method include Hierarchical K-Means, KD-trees, and data-independent Locally Sensitive Hashing.

In 803, the document summaries 105s for the set of documents 105 may be provided for display to the user for further review and interaction.

Steps 801 and 802 may be repeated each time the relevance value 157 is indicated, such as when the user activates a relevance input object. The relevance reference 140 is modified in response to the relevance value 157. For example, if the user indicates that document d2 (shown in FIG. 9) is also relevant, the relevant reference 140 is revised to become intermediate point between d1 and d2, and the set of documents identified as nearest neighbors is determined with respect to the new position of the relevant reference 140. If more than two documents are selected as relevant, the relevant reference 140 will be set to the mean of the vector positions of the more than two documents.

Additionally, in the step 801, the position of the relevant reference 140 may be revised if a relevance value 157 is provided for a document that indicates the document is not relevant. The position of the relevant reference 140 may be described by the following equation, which can be implemented to be executed on a computer:

$$v = {\sum }_{i} \frac{{v}_{i}}{{N}_{v}} - c ( {\sum }_{j} \frac{{w}_{j}}{{N}_{w}} - {\sum }_{i} \frac{{v}_{i}}{{N}_{v}} )$$

where c is a constant greater than 0, vᵢ is the vector for relevant document i, and wⱼ is the vector for a not relevant document j, Nᵥ is the number of relevant documents, and N_{w} is the number of irrelevant documents.

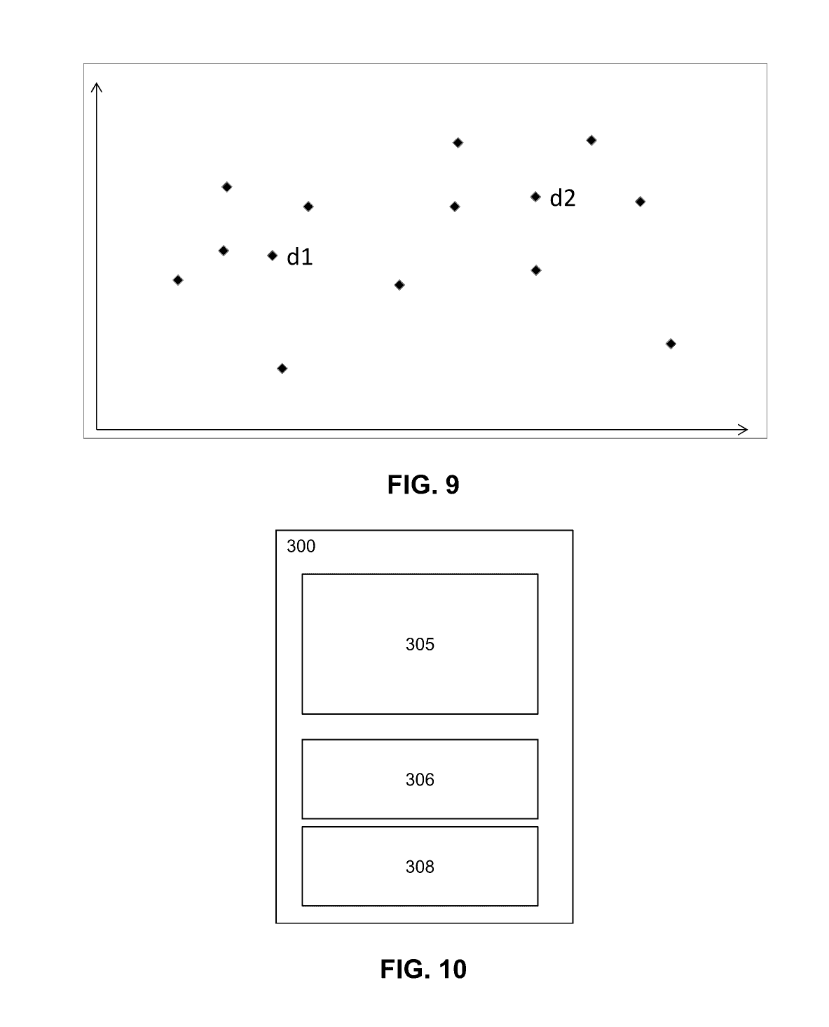

The systems and methods described above may be implemented on one or more computers in a variety of different configurations. One possible configuration is shown in FIG. 10. Computer 300 comprises a display 305 on which window 200 may be displayed. Computer 300 may comprise a microprocessor 306 and a memory 308. The memory 308 may contain certain instructions for the systems and methods described herein. The microprocessor 306 may execute certain instructions for the systems and methods described herein. For example, the computer 300 may be a desktop computer, laptop computer, server computer, tablet computer, a mobile phone such as an IPHONE phone or an ANDROID phone, a computing watch such as the APPLE WATCH or the SAMSUNG GEAR, or another computing device, including but not limited to GOOGLE GLASS or other mobile computing devices. The computer 300 may be provided with an Internet browser, such as INTERNET EXPLORER or GOOGLE CHROME, that provides the capability to display a window 200 in the display 305. In another embodiment, the window 200 is displayed through an app installed on the computer 300.

The computer 300 may communicate with a server computer 320 through a communication link 310. As is known in the art, a communication link 310 may take many forms, including but not limited to a cellular transmission, a WI-FI transmission, a cable, a network connection, a bus, or a combination of such connections. Like the computer 300, the server computer 320 may take many different forms, including a plurality of computers arranged in a cloud network. Server computer 320 may comprise a storage 350 that stores the documents 100, and may perform the steps depicted in FIG. E and FIG. J. In another embodiment, the storage 350 may be part of computer 300, which avoids the need for the computer 300 to regularly communicate through a communication link to the server computer 320.

In an embodiment, the computer 300 may allow a user to create a profile, which allows the computer 300 and/or the computing device 320 to save the user's relevance selections and other information about the user. The profile may be created directly or indirectly, such as through an existing profile (such as a GOOGLE+ profile, a FACEBOOK profile, or another user profile). The profile could retain information about a user's preferences, either indefinitely or for a limited time (in days, months, or years). Alternately, the profile would erase at least a portion of information about the user after each session use.

In other embodiments, the systems and methods described could identify relevant documents from a user with multiple clusters of preferences. For instance, a user may be interested in the diverse fields of “computation” on one hand, and “butterflies” on the other hand. In systems with a large number of documents that extend across multiple subject areas, such as the set of web pages available through the Internet, the systems and methods described herein could return a first cluster of documents related to the user's interest in computation and a second cluster of documents related to the user's interest in butterflies.

In other embodiments, documents 100 may be weighted with relevance information that comes from other users' use of the systems and methods described herein. For example, if user_i and user_j share the same field, and user_i has indicated certain documents as relevant or not relevant, the systems and methods may weight those documents accordingly for user_j.

In other embodiments, the window 200 may display a trending list of documents. For instance, the window 200 may display documents found relevant by a large portion of users. In other embodiments, additional inputs may be included to allow users to mark whether they like or dislike a document, and the trending list may indicate documents that are liked by a large portion of users.

What is claimed is:

1. A computer-implemented method of displaying information within a window displayed on a graphical user interface, the method comprising:
a. displaying in the window a plurality of document summaries;
b. displaying in the window, for each document summary in the list, a relevance input object;
c. receiving a relevance value from the relevance input object; and
d. updating the window display with a revised plurality of document summaries in an order determined at least in part by the relevance value.

2. The method of claim 1, wherein the updating the window display with a revised plurality of document summaries is performed directly in response to receiving the relevance value.

3. The method of claim 1, wherein each of the document summaries displays the document title and the document author.

4. The method of claim 1, wherein each relevance input object is displayed as either a check mark or an X symbol.

5. The method of claim 1, wherein each relevance input object is displayed as a heart.

6. The method of claim 1, wherein each relevance input object is displayed as a thumbs up or a thumbs down.

7. The method of claim 1, wherein the order in which the revised plurality of document summaries are displayed is determined at least in part using latent semantic analysis.

8. The method of claim 1, wherein the order in which the revised plurality of document summaries are displayed is determined at least in part using a weighted token matrix.

9. The method of claim 8, wherein:
a. each document summary is associated with a document;
b. each document is associated with a plurality of tokens; and
c. the weighted token matrix includes a value for each token for each document associated with the plurality of document summaries.

10. The method of claim 8, wherein the weighted token matrix is a dimensionally reduced weighted token matrix.

11. The method of claim 10, wherein the weighted token matrix has been subject to truncated singular value decomposition.

12. The method of claim 10, the weighted token matrix having a total variance prior to dimensional reduction, wherein the weighted token matrix is dimensionally reduced to capture a predetermined percentage of the total variance.

13. The method of claim 1, wherein the order in which the revised plurality of document summaries are displayed is determined at least in part using a nearest neighbor method.

14. The method of claim 8, wherein the order in which the revised plurality of document summaries are displayed is determined at least in part using a nearest neighbor method.

15. The method of claim 10, wherein the order in which the revised plurality of document summaries are displayed is determined at least in part using a nearest neighbor method.

16. The method of claim 1, wherein each document summary in the plurality of document summaries is associated with a document, wherein each document summary comprises a summary description of the associated document.

17. The method of claim 16, wherein each document is a poster.

18. The method of claim 16, wherein each document is an article.

19. The method of claim 1, further comprising:
a. receiving a search phrase entered into the window; and
b. generating the plurality of document summaries based upon the search phrase.

20. The method of claim 19, wherein the plurality of document summaries are generated based upon the search phrase by searching the text in each document summary for the search phrase.
